(19) United States
(12) Patent Application Publication
(10) Pub. No.: US 2026/0234033 A1
(43) Pub. Date: Aug. 13, 2026

(54) SYSTEMS, DEVICES, AND METHODS FOR ELECTRODIALYSIS-BASED HOME-SCALE DESALINATION

(71) Applicant: MASSACHUSETTS INSTITUTE OF TECHNOLOGY, Cambridge, MA (US)

(72) Inventors: Zachary STERNBERG, Cambridge, MA (US); Sahas GEMBALI, Cambridge, MA (US); Marie FLORYAN, Cambridge, MA (US); Quinn N. BOWERS, Cambridge, MA (US); Akshita GOYAL, Cambridge, MA (US); Jonathan BESSETTE, Cambridge, MA (US); Soraya HONARPARVAR, Cambridge, MA (US); Melissa BREI, Cambridge, MA (US); Michael S. BONO, Cambridge, MA (US); Shane PRATT, Cambridge, MA (US); Amos Greene WINTER, V, Carlisle, MA (US)

(21) Appl. No.: 19/152,807

(22) PCT Filed: Jul. 1, 2024
(86) PCT No.: PCT/US2024/036463

§ 371 Date: Jul. 31, 2025

Related U.S. Application Data
(60) Provisional application No. 63/524,526, filed on Jun. 30, 2023.

(51) Int. Cl. C02F 1/469; B01D 61/46; B01D 61/52; F16K 11/00

(52) U.S. Cl. CPC C02F 1/4693; B01D 61/46; B01D 61/52; F16K 11/00; B01D 2313/18; B01D 2313/501; C02F 2201/005; C02F 2209/03; C02F 2301/043

(57) ABSTRACT

Systems, devices, and methods for electrodialysis-based home-scale water desalination are disclosed. The system can include an electrodialysis stack having one or more membranes that is in fluid communication with a pump and a valve manifold system for desalinating a feed stream pumped into the electrodialysis stack. Various circuit architectures for the manifold system are possible to obtain the desired recovery ratios that outperform conventional reverse osmosis symptoms. The pump, electrodialysis stack, and valve manifold system, and additional components of the electrodialysis system can be packaged within dimensions of a reverse osmosis cabinet, which can provide for in-home installation and use, while also minimizing points of failure.

### CROSS REFERENCE TO RELATED APPLICATION

The present disclosure claims priority to and the benefit of U.S. Provisional Application No. 63/524,526, entitled “Systems, Devices, and Methods for Electrodialysis-Based Home-Scale Desalination,” filed on Jun. 30, 2023, the content of which is incorporated by reference herein in its entirety.

### FIELD

The present disclosure relates to systems, devices, and methods for fluid desalination, and more particularly relates to systems, devices, and methods for compact electrodialysis desalination of feed streams for small scale, personal water use having high recovery ratios.

### BACKGROUND

Throughout much of the developing world, access to safe, reliable drinking water remains a challenge, as it is often intermittently available, biologically contaminated, and/or too salty to drink. Drinking water is the most basic global health need to be addressed as per the World Health Organization (WHO), with access to clean drinking water also being one of the United Nations' (UN) Sustainable Development Goals. For example, water scarcity has become such a problem in countries like India that a recently proposed piece of legislation would mandate home-scale water desalination systems to have a 60% recovery ratio, which is significantly higher than existing systems. Moreover, in India, the demand for drinking water is expected to grow to 73 billion (Bn) cubic meters in 2025 and to 102 Bn cubic meters by 2050, thereby making it even more essential for membrane technology in home-scale setup to be more efficient.

In a recent LocalCircles survey, only 2% of participants indicated that they receive drinkable quality water from their local body, and 65% use some kind of at-home filtration mechanism to obtain drinking water. Further, there are also many households in India that have borewells dug in their houses to directly access groundwater that is untreated and often needs purification before drinking. Currently, even though local municipal bodies in India treat water for physical and biological contaminants before supplying it to households, high total dissolved salts (TDS) levels present in tap water make it unfit for drinking. High TDS presence is suspected in a wide array of degenerative diseases, such as hardening of the arteries, arthritis, kidney stones, gallstones, glaucoma, cataracts, hearing loss, emphysema, diabetes, and obesity.

Tap water salinity has increased the adoption rate of standalone home-scale water purification systems over the years. Water desalination techniques such as Reverse Osmosis (RO) can help reduce the TDS of water making it healthy for drinking when used in combination with a sediment filter and UV disinfection treatment. Approximately 12.94 million RO units are sold in India every year, with units holding between about 5 liters to about 15 liters of water, depending on the size, and are designed to be mounted on walls or fit inside kitchen cabinets. In fact, while RO is capable of removing up to 99%+ of the dissolved salts (ions), particles, colloids, organics, bacteria, and pyrogens from the feed water through semi-permeable membranes at the industrial scale, these systems have several shortcomings. First, the taste of water from RO-based systems has become an indicator of water quality for users over the years, with consumers associate the taste of 100 parts per million (ppm) TDS with clean water, even though 500 ppm is fit for drinking. Consequently, many users employ domestic water treatment systems on water already suitable for drinking due to taste preference, leading to excess waste water due to the low recovery of RO systems. On average, 75 liters of water is required to obtain just 15 liters of drinking water (i.e., the average per day consumption per family of four) from an RO system. That is a 20% recovery ratio, which is a measure of the efficiency of the system. This amount of water waste has caused increased stress on the groundwater table in countries like India, which has led to legislative proposals like the aforementioned requirement for any new home-scale desalination system to have a water recovery rate of at least 60%.

Electrodialysis (ED)-based membrane desalination technology (currently used in industrial desalination) has a water recovery rate of up to 90%, which makes it a potentially more sustainable alternative to the conventional RO system. Current ED-based systems, however, are not currently designed for home-scale desalination for numerous reasons. First, the industrial nature of electrodialysis-based desalination has conventionally utilized large equipment that has not been tailored for small-scale uses for personal consumption. Second, a person skilled in the will appreciate that the industrial desalination has not been able to be shrunk down effectively for such in-home uses at least because use of smaller components and/or omission of the components from the desalination system would adversely affect recovery ratios of the desalination system to the point that the system would be rendered ineffective.

Accordingly, there is a need for systems and methods for desalination technology that provides high recovery ratios while maintaining manufacturing, assembly, and service aspects of that are suitable for home-scale applications and usage.

### SUMMARY

The present disclosure is directed to systems, devices, and methods for electrodialysis-based home-scale water desalination. Specifically, a desalination system of the present embodiments can include an electrodialysis stack having one or more membranes that is in fluid communication with a pump and a valve manifold system for desalinating a feed stream pumped into the electrodialysis stack. Modifications to the design of the end cap can allow non-handedness of the end caps to facilitate low cost manufacture thereof. In some embodiments, the valve manifold system can separate a feed stream into concentrate and diluate streams that are fed to the electrodialysis stack and then run through another set of valves of the valve manifold system to separate the streams into waste and product. Various circuit architectures for the manifold system are possible to obtain the desired recovery ratios. The pump, electrodialysis stack, and valve manifold system, and additional components of the electrodialysis system, can be packaged within dimensions of a cabinet (e.g., a reverse osmosis cabinet or a sink cabinet), which can provide for in-home installation and use, while also minimizing points of failure.

One exemplary embodiment of a valve manifold system includes a matrix of valves, a static pressure regulator, a flow divider, and a bypass valve. The matrix of valves includes a set of valves located downstream of an electrodialysis stack that includes one or more membranes disposed between a pair of electrodes. The static pressure regulator is in fluid communication with the matrix of valves, with the static pressure regulator being located on a concentrate output stream. The flow divider is configured to separate a feed stream into a concentrate feed stream and a diluate feed stream prior to entry into the matrix of valves. The bypass valve allows the concentrate output stream to bypass the static pressure regulator.

The static pressure regulator can be located downstream of the electrodialysis stack. In some embodiments, the static pressure regulator can be located downstream of the matrix of valves. The static pressure regulator can be configured such that the concentrate output stream exiting the set of valves flows through the static pressure regulator before exiting as wastewater.

A ratio of the flow rate of the diluate feed stream to the concentrate feed stream through the matrix of valves is approximately in a range of about 20:1 to about 1:1. In some embodiments, a recovery ratio of the product in the product tank is approximately in a range of about 50% to about 95% of the feed stream circulating through the system. The bypass valve can be configured to be bypassed during a flush cycle when a power of a pump that is in fluid communication with the valve manifold system and the electrodialysis stack is modulated.

The set of valves can include a first pair of valves that are in fluid communication with one another and a second pair of valves that are in fluid communication with one another. In some embodiments, the matrix of valves can include a second set of valves that are located upstream of the electrodialysis stack. The second set of valves can include a first pair of valves that are in fluid communication with one another and a second pair of valves that are in fluid communication with one another.

In some embodiments, the system can include a second static pressure regulator located upstream of the matrix of valves or the electrodialysis stack. The second static pressure regulator can be located on a concentrate feed stream and can be in fluid communication with the second set of valves.

The system can include a first input conduit connecting an input side of the first pair of the first set of valves; and a second input conduit connecting an input side of the second pair of the second set of valves. In some embodiments, a first output conduit can connect an output side of a first valve of the first pair of valves and a first valve of the second pair of valves, and a second output conduit can connect an output side of a second valve of the first pair of valves and a second valve of the second pair of valves. At least one or more of the first input conduit, the second input conduit, the first output conduit, or the second output conduit can include a custom molded bus without fittings. In some embodiments, one or more brackets having a body with one or more recesses can be configured to receive a valve from the matrix of valves therein, the body having one or more extensions configured to couple the bracket to a supporting surface.

Another exemplary embodiment of a valve manifold system includes a matrix of valves, a static pressure regulator, and a flow divider. The matrix of valves includes a first set of valves and a second set of valves. The first set of valves is located upstream of an electrodialysis stack that includes one or more membranes disposed between a pair of electrodes, and the second set of valves is located downstream of the electrodialysis stack. The static pressure regulator is in fluid communication with the matrix of valves. The flow divider is configured to separate a feed stream into a concentrate feed stream and a diluate feed stream prior to entry into the matrix of valves.

The static pressure regulator can be located upstream of the matrix of valves or the electrodialysis stack, and further, the static pressure regulator can be in fluid communication with the first set of valves. The static pressure regulator can be located on the concentrate feed stream. At least one of the first set of valves can include a first pair of valves that are in fluid communication with one another and a second pair of valves that are in fluid communication with one another, or at least one of the second set of valves can include a first pair of valves that are in fluid communication with one another and a second pair of valves that are in fluid communication with one another.

A recovery ratio of the product in the product tank can be approximately in a range of about 50% or more of the feed stream circulating through the system. The matrix of valves can be configured to flip the concentrate feed stream and the diluate feed stream prior to entry into the electrodialysis stack. In some embodiments, the matrix of valves is configured to flip a concentrate output stream and a diluate output stream after exiting the set of valves.

One exemplary embodiment of a desalination system includes a pump, a valve manifold system in fluid communication with the pump, and an electrodialysis stack. The electrodialysis stack includes one or more membranes disposed between a pair of electrodes, and is in fluid communication with the pump and the valve manifold system. A feed stream circulates, in sequence, from the pump into the valve manifold system, with the feed stream being split in the valve manifold system into a concentrate stream and a diluate stream that exit the valve manifold system. The concentrate stream and the diluate stream are fed through the electrodialysis stack for ion removal via the one or more membranes, with the concentrate stream and the diluate stream exiting the electrodialysis stack into the valve manifold system, and the concentrate stream exiting the valve manifold system as waste and the diluate stream exiting the valve manifold system as a product. A recovery ratio of the product is approximately in a range of about 50% or more of the feed stream circulating through the system.

The desalination system can be disposed in a cabinet having the dimensions of a conventional reverse osmosis (RO) cabinet. For example, the desalination system can be configured to fit within a rectilinear envelope measuring about 300 mm×about 280 mm×about 500 mm. In some embodiments, the desalination system can include an acid dosing pressure pump and an acid dose vessel in fluid communication with one or more of the pump or the valve manifold system, with the acid dosing vessel being configured to receive waste exiting the valve manifold system via the acid dosing pressure pump. The desalination system can include an electrode rinse stream that passes from the acid dose vessel to the first end cap of the pair of end caps, with a contaminated electrode rinse stream exiting a second end cap of the pair of end caps. In some embodiments, the system can include one or more of an antiscalant, a conductivity sensor, a feed water tank, or a feed water inlet that are in fluid communication with the pump to flow the feed stream from the feed water inlet, through the pump, and into the valve manifold system.

The valve manifold system can further include a first set of valves and a second set of valves, with the electrodialysis stack being disposed downstream from the first set of valves and upstream of the second set of valves. In some embodiments, the product can flow through one or more of a conductivity sensor, a pH sensor, an infuser, a UV filter, or a product tank after exiting the second set of valves.

The one or more membranes of the electrodialysis stack can further include a cation membrane and an anion membrane separated by one or more spacer membranes, with the cation membrane and the anion membrane having a tortuous channel formed therein. In some embodiments, the electrodialysis stack can further include a pair of end caps, with each end cap engaging an electrode of the pair of electrodes without reinforcement features to facilitate the coupling. The concentrate stream and the diluate stream can enter a first end cap of the pair of end caps, with the feed stream being split into a concentrated water stream and a diluate water stream that exits a second end cap of the pair of end caps. The one or more membranes can be coupled to the pair of end caps without a center support member. In some embodiments, the system can include a static pressure regulator that can be configured to reduce a flow rate in the concentrate stream relative to the diluate stream.

A recovery ratio of the product can be approximately in a range of about 50% to about 95% of the feed stream circulating through the system. Alternatively or additionally, a recovery ratio of the product can be approximately in a range of about 50% to about 90% of the feed stream circulating through the system. In some embodiments, the concentrate stream can be configured to recirculate through the pair of electrodes to rinse the electrodes.

One exemplary embodiment of an end cap includes a body, one or more inlet valves and outlet valves disposed equidistant from one another within the body, a pair of asymmetrical electrode rinse channels terminating at the one or more outlet valves, and an electrode connection formed at an inner periphery of the end cap. The body includes a top surface, a bottom surface, and a plurality of bores extending from the top surface to the bottom surface for coupling the body to an electrodialysis stack. The end cap includes rotational symmetry such that the end cap is configured to be coupled to a top or bottom of the electrodialysis stack.

The end cap can include one or more throughholes for receiving an alignment pin therein, with the alignment pin being keyed to couple to the electrodialysis stack in a single orientation to prevent leakage therefrom. In some embodiments, the end cap can be devoid of reinforcement features for coupling the end cap to the electrodialysis stack.

One exemplary embodiment of a method of desalinating a feed stream includes flowing at least a portion of a feed stream through a flow restrictor, flowing at least another portion of the feed stream and the stream exiting the flow restrictor through a matrix of valves and an electrodialysis stack that includes one or more membranes disposed between a pair of electrodes, and separating a fluid from a salt content in the feed stream to form a product.

The method can further include splitting the feed stream into a concentrate feed stream and a diluate feed stream. The feed stream can be flowed through a flow divider to split the feed stream. In some embodiments, the method can further include flipping the concentrate feed stream and the diluate feed stream via the matrix of valves prior to entry into the electrodialysis stack. The matrix of valves can include a first set of valves disposed upstream of the electrodialysis stack and a second set of valves disposed downstream of the electrodialysis stack.

In some embodiments, the method can include flowing at least a portion of a diluate stream exiting the second set of valves through a second flow restrictor. In some embodiments, the method can include collecting the diluate stream exiting the second set of valves as product and discarding a concentrate stream exiting the second set of valves.

### BRIEF DESCRIPTION OF THE DRAWINGS

This disclosure will be more fully understood from the following detailed description, taken in conjunction with the accompanying drawings, in which:

FIG. 1A is a schematic front view of one embodiment of an electrodialysis (ED) stack used in a ED system of the present embodiments;

FIG. 1B is a schematic front view of the ED stack of FIG. 1A;

FIG. 1C is a schematic top view of the components of a cell pair of a membrane used in the ED stack of FIG. 1A;

FIG. 2A is a schematic representation of components of an ED system of the present embodiments;

FIG. 2B is a schematic representation of the ED system having the components of FIG. 2A, including a valve manifold system, integrated with additional components of the ED system and/or components that can be used in conjunction with the ED system;

FIG. 3A is a schematic representation of a circuit architecture of the valve manifold system of FIG. 2B;

FIG. 3B is a schematic representation of one embodiment of a circuit architecture of a valve manifold system that can be used as the valve manifold system of the ED system of FIG. 2B;

FIG. 3C is a schematic representation of another embodiment of a circuit architecture of a valve manifold system that can be used as the valve manifold system of the ED system of FIG. 2B;

FIG. 3D is a schematic representation of still another embodiment of a circuit architecture of a valve manifold system that can be used as the valve manifold system of the ED system of FIG. 2B;

FIG. 3E is a schematic representation of another embodiment of a circuit architecture of a valve manifold system that can be used as the valve manifold system of the ED system of FIG. 2B;

FIG. 3F is a schematic representation of yet another embodiment of a circuit architecture of a valve manifold system that can be used as the valve manifold system of the ED system of FIG. 2B;

FIG. 4A is a schematic illustration of the valve manifold system of the ED system of FIG. 2B;

FIG. 4B is a schematic illustration of one embodiment of a valve manifold system that can be used in the ED system of FIG. 2B;

FIG. 5A is a schematic illustration of the ED system of FIG. 2B disposed in an RO cabinet;

FIG. 5B is a schematic illustration of a prior art RO system disposed in an RO cabinet;

FIG. 5C is a table illustrating the comparison of volume and usage of each component of the cabinet of FIG. 5A and the cabinet of FIG. 5B;

FIG. 6 is a side view of the cabinet of FIG. 5A;

FIG. 7A is a perspective view of one embodiment of a bracket that can support the valve manifold system of FIG. 4A;

FIG. 7B is a top view of the bracket of FIG. 7A;

FIG. 7C is a perspective view of one embodiment of a bracket that can support the cabinet of FIG. 5A;

FIG. 7B is a top view of the bracket of FIG. 7C;

FIG. 8 is a side view of one embodiment of a snap fit brace that can be used in conjunction with the valve manifold system of FIG. 4A;

FIG. 9A is a perspective top view of one embodiment of an end cap that can be used with the ED stack of FIG. 2B;

FIG. 9B is a perspective bottom view of the end cap of FIG. 9A; and

FIG. 10 is a schematic top view of another embodiment of an end cap that can be used with the ED stack of FIG. 2B.

### DETAILED DESCRIPTION

Certain exemplary embodiments will now be described to provide an overall understanding of the principles of the structure, function, manufacture, and use of the systems, devices, related components (e.g., membranes, electrodes, end caps, brackets, etc.), and techniques disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Further, to the extent features, layers, sides, objects, steps, or the like are described as being “first,” “second,” third,” etc., and/or “lower,” “upper,” “middle,” etc., such numerical and/or location ordering/identification is generally arbitrary, and thus such numbering can be interchangeable unless indicated or otherwise understood by those skilled in the art to not be interchangeable.

To the extent that the instant disclosure includes various terms for components and/or processes of the disclosed systems, methods, and the like, one skilled in the art, in view of the claims, present disclosure, and knowledge of the skilled person, will understand such terms are merely examples of such components and/or processes, and other components, designs, processes, and/or actions are possible.

At least one novel aspect of the present disclosure lies in a compact fluid control system and components for a home-scale water desalination system. The desalination system can include an electrodialysis (ED)-based system having a pump, a valve manifold, and a stack in fluid communication with one another to desalinate a feed stream of fluid flowing therethrough. One or more custom end caps can be molded to the stack to facilitate entry and filtration of feed streams and exit streams to and from the stack. Additional components can be added to an input side and an output side of the system to feed the stream into the system and collect the product stream exiting the valve manifold while recycling and/or discarding the waste stream. Each stream can pass through a matrix of valves that can be used to selectively control the input streams for the diluate and concentrate streams to eliminate buildup of scale. By way of example, control of the input streams can include selectively flipping the flow of fluid through one or more paths within the matrix of valves and/or otherwise selectively directing fluid along different paths of the matrix. The desalination system can be sufficiently compact to be disposed in a cabinet having the dimensions of a cabinet, e.g., a standard sink cabinet and/or a conventional reverse osmosis cabinet.

### Electrodialysis Stack

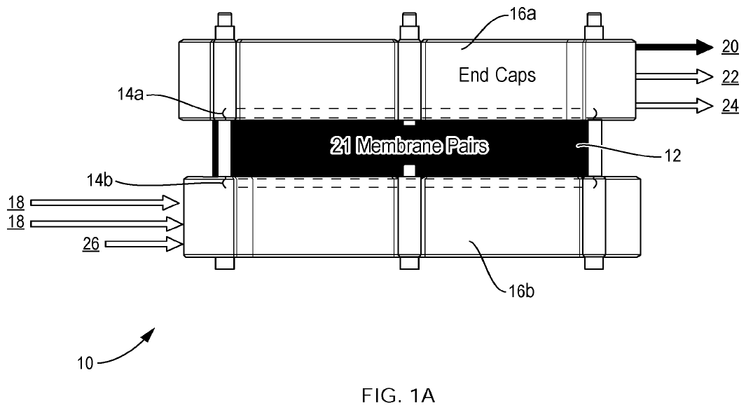

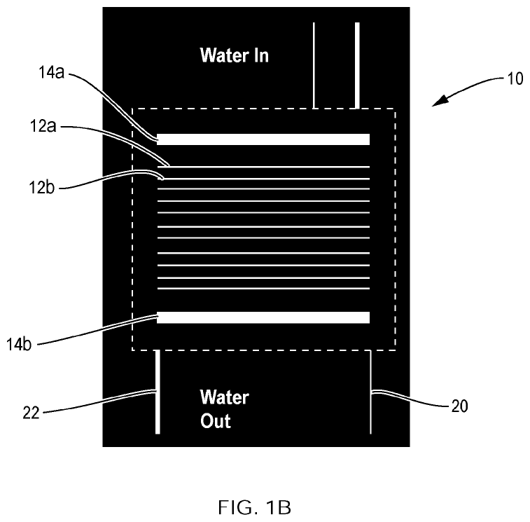

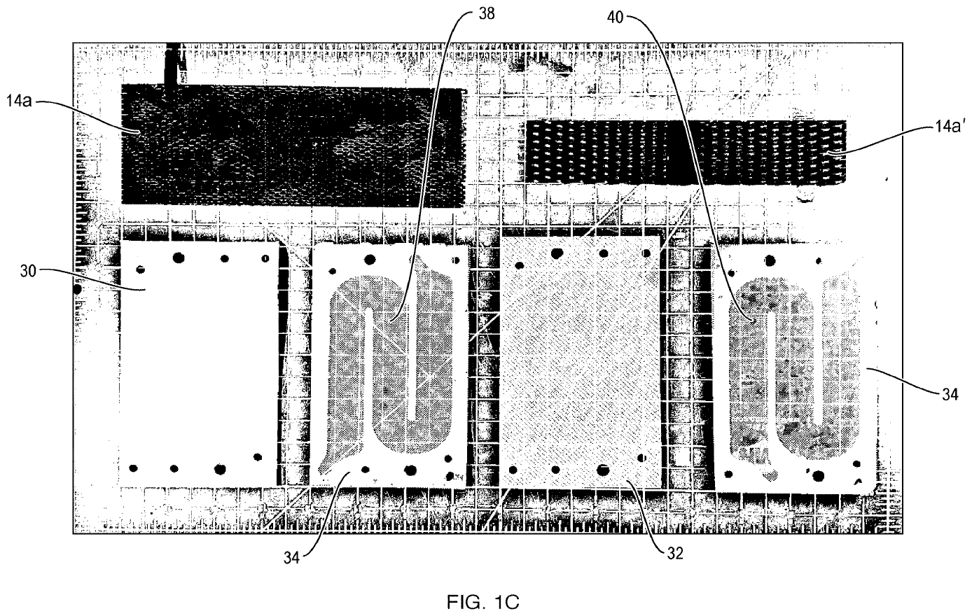

FIG. 1A illustrates one embodiment of an electrodialysis (ED) stack 10 used in the desalination system of the present embodiments. As shown, the ED stack 10 can include one or more membranes 12 disposed between a pair of electrodes 14a, 14b. The membranes 12 can be arranged in pairs to filter one or more fluid streams received in the ED stack 10 as discussed in greater detail below. While twenty-one (21) pairs of membranes 12 are shown in FIG. 1A, it will be appreciated that this number is merely exemplary, and twenty (20) or less, or twenty-two (22) or more pairs of membranes can be used in the ED stack 10. Each of the cell pairs can include one cation exchange membrane (CEM) 30, one anion exchange membrane (AEM) 32, and a pair of spacers 34. The arrangement of the components within the cell pair can include a stack of the CEM 30, the spacer 34, the AEM 32, and another spacer, as discussed with respect to FIG. 1C below. The electrodes 14a, 14b can be made of one or more of platinum, copper, graphite, titanium, brass, platinum-coated titanium, and/or silver, among other materials known to those skilled in the art. Two sample electrodes are shown in more detail in FIG. 1C.

The stack of membranes 12 can be compressed inside two end caps 16a, 16b to close the system. The end caps 16a, 16b can be solid and configured to prevent leakage. One or more feed water streams 18 can pass through the ED stack 10 where the electrodes 14a, 14b separate salt ions and heavy metal ions into cations and anions, and direct them into the concentrate water stream 20 for disposal. A diluate water stream 22 can flow out of the end cap 16a, with the diluate water stream 22 having desalinated water therein that is free, or at least substantially free, of the concentrate water stream 20. In some embodiments, an electrode rinse stream 24 can also pass through the ED stack 10, the stream 24 being used to clean the electrodes. The electrode rinse stream 24 can exit the outlet as contaminated electrode rinse stream 26 and be discarded to waste. It will be appreciated that while the streams 18, 20, 22, among others, are described as feed water streams throughout this specification, water is simply an example embodiment of each of the streams. For example, one or more of each of the streams 18, 20, 22 can flow a different fluid therethrough, e.g., alcohol, slurries, and the like. It will also be appreciated that the electrode rinse stream may be optional, e.g., omitted.

FIGS. 1B-1C illustrate the arrangement of the electrodes 14a, 14b and the membrane pairs 12a, 12b of the ED stack 10 in greater detail. As shown, the membrane pairs 12a, 12b can be arranged horizontally between the electrodes 14a, 14b to filter the feedwater, though other arrangements of the membrane pairs 12a, 12b are possible as can be appreciated by one skilled in the art. As mentioned above, each membrane or cell pair 12a, 12b can include the cation exchange membrane (CEM) 30 and the anion exchange membrane (AEM) 32, respectively, with the cation and anion exchange membranes being separated by the spacer 34, and an additional spacer that is rotated about its axis, e.g., flipped by 180 degrees on two axes, to guide an alternating flow path. The spacer 34 can have a channel 38, 40 therein, respectively, to allow for the exchange of ions while the feed water flows therethrough. As shown, the channels 38, 40 can have a tortuous path through the membrane to increase a time that the feedwater flows through the membrane, in turn increasing the desalination of the feed water stream 18.

A size of the cation membrane 30 and/or the anion membrane 32 can vary. In some embodiments, membranes with torturous routes, such as channels 38, 40 as discussed above, can be larger than their conventional counterparts to accommodate for the increased time that the feed water flows through the membrane pairs 12a, 12b. Absent such an increase in size, the increased time within the membrane pairs 12a, 12b can cause additional leaking through the ED stack 10. As a result of the size increase in the cation membrane 32 and/or the anion membrane 34, the membrane pairs 12a, 12b can be disposed within the ED stack 10 without a center support. That is, the membrane pairs 12a, 12b can be secured to the end caps 16a, 16b of the ED stack 10 at the periphery of the membrane pairs 12a, 12b, and not at a center thereof. Such a configuration allows for deflection of the membrane pairs 12a, 12b, which can reduce leakage of the ED stack 10.

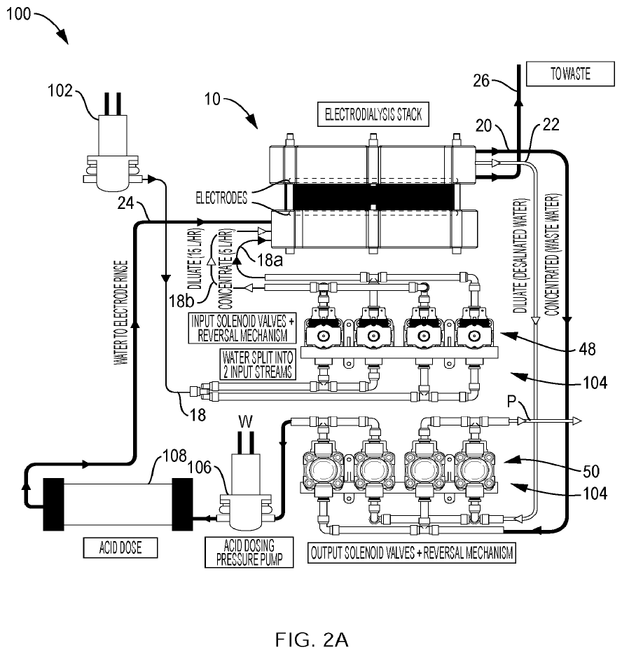

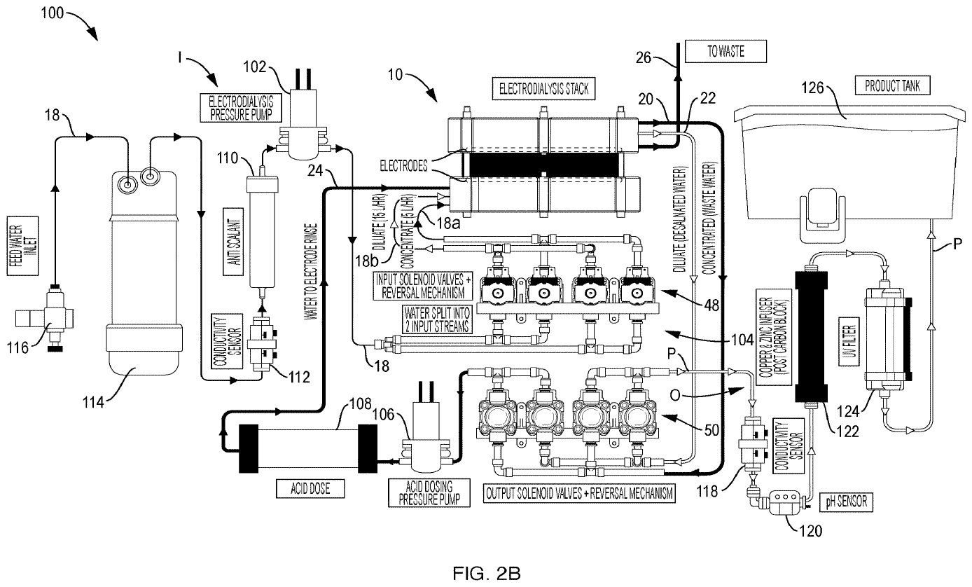

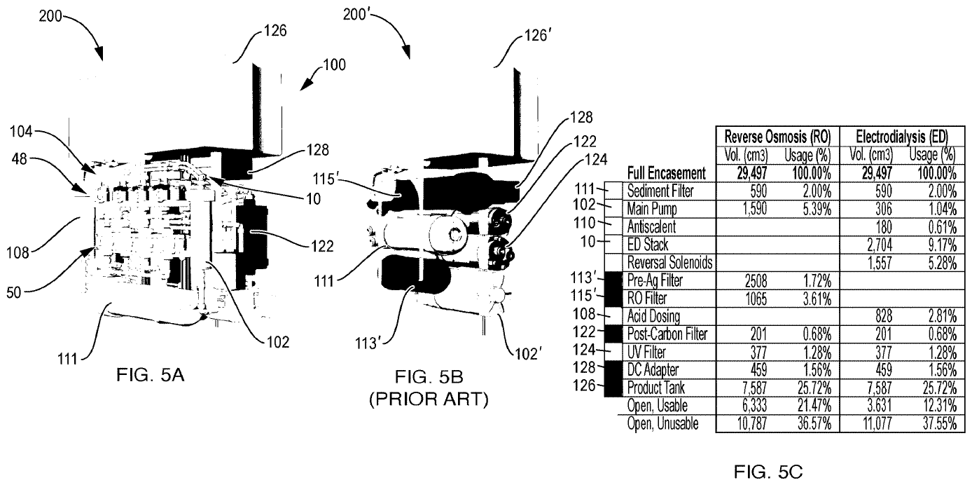

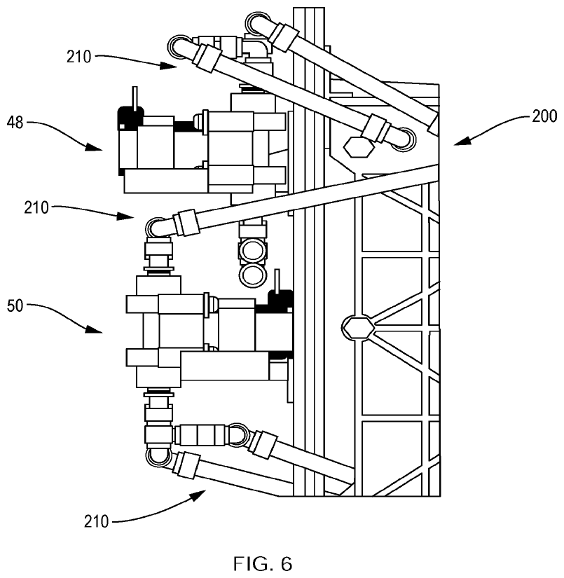

FIGS. 2A-2B illustrate an example embodiment of an ED system 100 having the ED stack 10 included as part of the system for desalinating a feed water stream to achieve clean drinking water from electrodialysis. Specifically, FIG. 2A illustrates a layout of the particular components of the ED system 100 while FIG. 2B illustrates a layout of an example embodiment of the components of FIG. 2A integrated into a more broad depiction of the ED system 100. The ED system 100 can be sized to fit within a cabinet 200, as discussed in greater detail with respect to FIG. 5A below, though in some embodiments, the ED system 200 can be sized in a way to reduce and/or minimize pretreatment such that the cabinet 200 is limited to housing the components of FIG. 2A.

The components of the ED system 100 illustrated in FIG. 2A include an ED pump 102, a valve manifold system 104, the ED stack 10, an acid dosing pressure pump 106, and an acid dose vessel 108, all in fluid communication with one another. It will also be appreciated that one or more of the acid dosing pressure pump 106 and the acid dose vessel 108 may be optional, e.g., omitted. Fluid communication between components can be formed via one or more conduits, such as pipes or tubing, valves, and other features that can pass fluid from one component to another that would be appreciated by one skilled in the art. Fluid can pass between the components via these flow paths in the directions of the arrows indicated in the figures, though it will be appreciated that in some embodiments, the flow can occur in an opposite direction. That is, it will be appreciated that a flow path in a given stream may be different than a flow path in a different stream. As shown, the feed water stream 18 can flow from the ED pump 102 through to the valve manifold system 104 where it is split into two input streams: a concentrate feed stream 18a and a diluate feed stream 18b that passes through the valve manifold system 104. The valve manifold system 104 can include input solenoid valves and a reversal mechanism for flowing the input streams in opposite directions. The ED stack 10 can be oriented above the valve manifold system 104 within a cabinet 200, as discussed in greater detail with respect to FIG. 5A below, though in some embodiments, the ED stack 10 can be positioned below the valve manifold system 104. A detailed discussion of the valve manifold system 104 is included in greater detail below.

The feed streams 18a, 18b can exit a first set of valves 48 of the valve manifold system 104 and enter the ED stack 10, e.g., the end cap 16b, for ion removal or ion transfer. In some embodiments, a water to electrode rinse 24 can be fed to the ED stack 10 from the acid dose vessel 108. After filtration through the ED stack 10, the concentrate water stream 20 and the diluate water stream 22 can exit through an outlet (not shown) in the second end cap 16b (FIG. 1A). The concentrate water stream 20 can include wastewater and the diluate water stream 22 can include desalinated water from the feed streams 18a, 18b. In some embodiments, a contaminated electrode rinse stream 26 can exit the outlet and be discarded to waste.

The concentrate water stream 20 and the diluate water stream 22 can pass through a second set of valves 50 of the valve manifold system 104 with the concentrate water stream being passed as wastewater W to the acid dosing pressure pump 106 and to the acid dose vessel 108 for reintroduction into the system 100 as the electrode rinse stream 24. The diluate water stream 22 can meanwhile pass through and out of the valve manifold system 104 as a product stream P for collection.

FIG. 2B illustrates an example embodiment of the ED system 100 with the components illustrated in FIG. 2A in fluid communication with additional components that provide water stream sources and outputs for the various streams in the system. The components discussed in FIG. 2A can be in fluid communication with one or more additional components on the inlet side I of the ED system 100 and/or on an outlet side O of the ED system 100. As shown, the ED pump 102 can be in fluid communication with one or more of an antiscalant 110, a conductivity sensor 112, a feed water tank 114, and/or a feedwater inlet 116 to pass the feed water stream 18 from the feedwater inlet 18, through the ED pump 102, and into the valve manifold system 104. Moreover, the addition of the components on the inlet side I does not impact the number of ED pumps 102 used in the ED system 100, with a single pump 102 being used to create the inlet input streams 18a, 18b, as shown. The use of a single pump to create both input streams 18a, 18b can decrease the size, cost, and complexity of the ED system 100, making it more appropriate for use as a home-scale water purification system compared to a system where multiple pumps create input streams 18a, 18b. While these components are shown arranged in series, a person skilled in the art will recognize that one or more of these components can be arranged in parallel and/or omitted from the path through which the feed water stream 18 can flow. A person skilled in the art will recognize the function of each of these components in the water desalination process and therefore a detailed discussion of the functions of each of these components is omitted herein for the sake of brevity. Specifically, the feed water tank 114 and the antiscalant 110 can be used as prefiltration for the desalination step. The feed water tank 114 can be a cartridge filter that aims to remove sediment and can be a common pretreatment step for desalination systems. The antiscalant 110 can be an optional antiscalant cartridge, which can function with ion-exchange resin disposed within that can reduce the amount of scale forming compounds in the water where scale is chemical precipitation residue. The chemical precipitation residue can often be in the form of calcium carbonate, which may form on the desalination membranes, thereby hindering their performance. The acid dosing pressure pump 106 and the acid dose vessel 108 can work in tandem to mitigate scaling.

On the outlet side O of the ED system 100, the product stream P can flow through one or more of a conductivity sensor 118, a pH sensor 120, a copper/zinc post carbon treatment or infuser 122, a UV filter 124, and/or a product tank 126 for storage, as shown. While these components are shown arranged in series, a person skilled in the art will recognize that one or more of these components can be arranged in parallel and/or omitted from the path through which the product stream P can flow. A person skilled in the art will recognize the function of each of these components in the water desalination process and therefore a detailed discussion of the functions of each of these components is omitted herein for the sake of brevity. For example, the copper/zinc post carbon treatment or infuser 122 can be included to influence taste of the water, while the UV filter 124 can be included for disinfection. In some embodiments, a sediment filter 111 (shown in FIG. 5A) can be included on the inlet side I, the outlet side O, or both.

It will be appreciated that while some of the components of the inlet side I and the outlet side O already exist with respect to RO systems, changes to fluid controls and pressure pumps can be made for these components to operate with the ED system 100 of the present embodiments. For example, existing RO systems can use industrial components that are large in volume and are not scalable for manufacturing, thereby yielding lower recovery ratios, e.g., approximately 20% (e.g., using 75 liters of feed water to recover 15 liters), than the recovery ratios of the ED system 100 of the present embodiments, e.g., approximately 75% (e.g., using 20 liters of feed water to recover 15 liters). In some embodiments, a recovery ratio of the ED system of the present embodiments can be approximately in a range of about 50% to about 90%, approximately in a range of about 50% to about 90%, approximately in a range of about 60% to about 83%, approximately in a range of about 50% to about 80%, approximately in a range of about 60% to about 80%, and/or approximately in a range of about 60% to about 75%, with the recovery ratio being measured as an amount of product P recovered from an amount of the feed water stream 18 can be approximately in the range of about 50% to about 90%, and/or approximately in the range of about 50% to about 95%, and/or approximately in the range of about 50% to about 99%.

Electrodialysis has not been conventionally implemented at the home-scale size due, at least in part, to excessive cost and volume. The required salt cut and production rate of an electrodialysis system necessitates sufficient membrane area and electrode material, which using the current state-of-the-art, increases the cost and volume beyond what is feasible for home-scale systems. The model-based design and optimization of the spacer geometry, thicknesses, and materials provided for herein, however, has increased performance of the present embodiments and subsequently lowered the cost and volume required. For example, a redesign of system components and fittings with allocated space within a cabinet, along with a detailed design for manufacturing (DFM), analysis, and plan, proved to be appropriate to create a viable product.

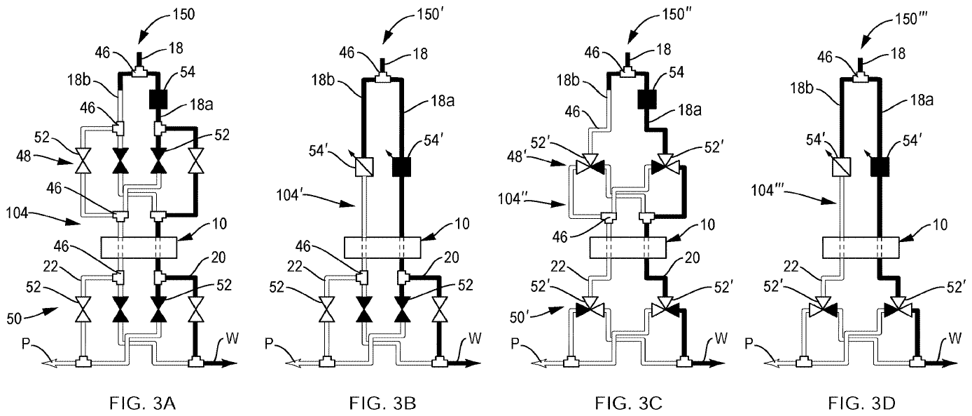

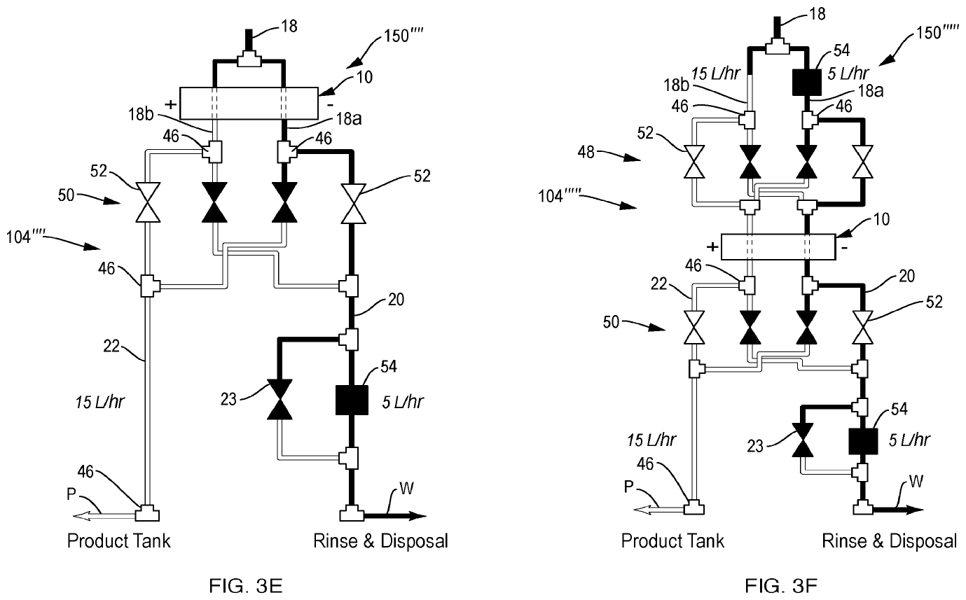

FIGS. 3A-3D illustrate example embodiments of fluid circuit architectures in which the valve manifold system 104 can be arranged to flow fluid through the ED system 100, as discussed with respect to FIGS. 2A and 2B. Management of the dynamic fluid streams in the ED system 100 can be performed using a number of reversal network modules, e.g., circuit architectures, as part of the system 100, which can be inclusive of the volumetric constraints and integration of new components into the current system architecture. As shown in FIG. 3A, for example, an example circuit architecture 150 of the valve manifold system 104 can include the arrangement shown in FIGS. 2A and 2B, with the water feed stream 18 passing through a flow divider 46, e.g., T/Y-Splits, to separate the water feed stream 18 into a concentrate feed stream 18a and a diluate feed stream 18b that passes through the valve manifold system 104, as discussed above.

Each stream 18a, 18b can pass through a matrix of valves that can be used to flip the input streams for the diluate 18b and concentrate 18a to eliminate buildup of scale, by way of example, as discussed further below. For example, the matrix of valves can include a first set of valves 48, e.g., four solenoid valves 52, that is located upstream of the ED stack, with each stream being passed through the ED stack 10 before flowing through a second set of valves 50, e.g., four solenoid valves 52, located downstream of the ED stack 10. The concentrate stream 20 can then be passed to the acid dosing pump 106 and the diluate stream 22 flowing out as the product stream P. The valves 52 can be standard solenoid valves, though in some embodiments the architecture can include multichannel solenoid valves, as discussed further below. While four solenoid valves are shown in each of the first and second sets of valves 48, 50, it will be appreciated that the number of valves in each set can vary. Moreover, each set of valves 48, 50 can include an equal number of solenoid valves 52, though in some embodiments, different numbers of valves can be used in each set 48, 50. Lastly, while some solenoid valves 52 are shown open while others are closed, it will be appreciated that FIGS. 3A-3D illustrate a snapshot of the circuit architecture and in an alternate state, open valves can become closed and vice versa. The water feed stream 18, the concentrate feed stream 18a, and the diluate feed stream 18b can flow through a network of paths, e.g., one or more fluid paths that are defined by a tube, a pipe, or the like, of any length that extends between the valves 52 that form the matrix, and/or the valve manifold system 104 and the ED stack, and/or any components of the ED system 100 that are in fluid communication with one another.

The circuit architecture 150 can include a static pressure regulator, flow restrictor, and/or flow regulator 54. For the purposes of the present disclosure, a flow restrictor and/or a flow restriction that results from the flow restrictor can be understood to be anything that changes a given flow rate and/or path of a flow running therethrough. As shown, the static pressure regulator 54, e.g., a needle valve, can be placed on the upstream of the ED stack 10, and the first and second sets of valves 48, 50 on the concentrate feed stream 18a to drop the pressure, and/or induce a higher resistance, e.g., forming a batch loop, of the concentrate feed water stream 18a or brine before it enters the ED stack 10 to minimize and/or eliminate the pressure in the stack. That is, having the static pressure regulator 54 upstream of the ED stack 10 can allow control of pressure throughout the ED system 100 by minimizing a flow rate of brine through the system by changing the hydraulic resistance to reduce the flow rate of the concentrate feed stream 18a relative to the diluate feed stream 18b. For example, a ratio of the flow rate of the diluate feed stream 18b to the concentrate feed stream 18a in the ED system 100 can be approximately in a range of about 20:1 (i.e., about 95% recovery) to about 1:1, approximately in a range of about 10:1 to about 1:1, approximately in a range of about 10:1 to about 5:1, approximately in a range of about 10:1 to about 4:1, approximately in a range of about 5:1 to about 1:1, approximately in a range of about 4:1 to about 1:1, and/or approximately in a range of about 5:1 to about 4:1. Low pressure of the concentrate feed stream 18a can be preferred as such low pressures can minimize a pressure differential between the concentrate feed stream 18a and the diluate feed stream 18b, which can be attributed to compliance of the endcaps 16a, 16b. Large pressure differentials between the two streams 18a, 18b can cause leakage, which can be mitigated by the static pressure regulator 54 being disposed upstream of the ED stack 10. It will be appreciated that, in some embodiments, the static pressure regulator 54 can be disposed outside, or external to, the valve manifold system 104 to create extra flow resistance outside of the circuit architecture 150. While a plurality of static pressure regulators 54 can be used, a single pressure regulator 54 disposed upstream of the ED stack 10, as shown, can, in some embodiments, result in a satisfactory minimization in leakage and the desired water purification performance without the cost and complexity of incorporating multiple pressure regulators. Two pressure regulators, with one disposed upstream and one downstream of the ED stack 10, as shown, can, in some embodiments, minimize the pressure differential across the membranes 12a, 12b, which can in some embodiments allow for the use of thinner membranes and/or a larger flow path area without unsatisfactory leakage or damage to the membranes.

Orientation of the static pressure regulator 154 can vary. In some embodiments, the static pressure regulator 54 can be disposed downstream of the ED stack 10 without negative impact on performance, though pressures at the input I of the ED stack 10 typically cannot be individually controlled in such embodiments. In such embodiments, the number of valves used can be reduced by half, e.g., four valves. For example, in some embodiments, one of the sets of valves 48, 50 can be eliminated such that the ED system 100 includes a single set of four valves. The first set of valves 48 located upstream of the ED stack 10 can be eliminated such that the ED system 100 operates with streams flowing through the second set of valves 50. In some embodiments, the second set of valves 50 that is located downstream of the ED stack 10 can be eliminated, though it will be appreciated that in some instances when the architecture includes only the first set of valves 48 located upstream of the ED stack, an amount of diluate, e.g., brine can undesirably be passed, e.g., leaked, to the product. Leakage can be monitored by one or more sensors and/or monitors disposed at, on, and/or near the static pressure regulator 154 to determine extent of leakage. In some embodiments, the static pressure regulator 54 can be disposed downstream of the solenoid valves 52, though such embodiments may result in the ED stack 10 having a higher pressure, e.g. back pressure, which can cause it to be prone to external leakage. Back pressure typically is not a factor when the static pressure regulator 154 is upstream of the solenoid valves 52.

Over time, the channel for the concentrate stream 18a can experience scaling and buildup. To minimize the impact of this scaling and reduce downtime of the valve manifold system 104, the circuit architecture, e.g., the reversal network module 150, can be designed to flush the channels through which each feed water stream 18a, 18b flows, as well as swap which channel contains the concentrate and which contains the diluate. The matrix of solenoids 52 and flow dividers 46 can be used to flip or switch the input streams for the diluate 18b and concentrate 18a, then restore the streams for the output. In some embodiments, two conditions can be used to define which is the diluate and which is concentrate: (i) the flow rate, e.g., about 5 L/hr for concentrate and about 15 L/hr for diluate; and (ii) the polarity of the electrodes 14a, 14b, which can define the direction in which the ions are moving. It will be appreciated that the flow rate of the concentrate stream 18a can influence recovery ratio and concentrate total dissolved salts (TDS). The reversal ideally occurs about every 7 L of clean water produced, with a brief flush to disposal in between each cycle. Additional systems to reduce scale buildup include sediment filtration and antiscalant stages prior to entering the ED stack 10 and acid dose vessel 108 after the ED stack 10, prior to the electrode rinse.

The circuit architecture 150 of the present embodiments of the valve manifold system 104 differs from existing RO systems in a number of ways. For example, existing RO systems force a single feed water stream through a filter to reduce salinity, whereas the present ED system 100 can split the feed water stream 18 into two streams, the diluate stream 18b and the concentrate stream 18a, prior to entry to the ED stack 10. The charge across the electrodes 14a, 14b can move the salt ions out of the diluate stream 18b and into the concentrate stream 18a. The concentrate water stream 20 can then cycle through as wastewater W, as discussed above, to rinse the electrodes and is then disposed of, while the diluate water stream 22 can continue to the outlet side O of the ED system 100, e.g., for final UV disinfection 124 and so forth, to exit as product P before being deposited into the product tank 126.

FIGS. 3B-3D illustrate alternate embodiments of circuit architectures 150′, 150″, 150′″ that can be used to optimize the reversal module architecture of the valve manifold systems 104′, 104″, 104′″, respectively. As shown, the circuit architectures 150′, 150″, 150′″ can differ from that of the circuit architecture 150 of FIG. 3A in that these architectures include electronic pressure regulators (EPRs) 54′ in lieu of static pressure regulators 54, and/or multichannel solenoid valves 52′ in lieu of standard solenoid valves 52 in the arrangements shown. Specifically, FIG. 3B illustrates a circuit architecture 150′ having a pair of EPRs 54′, in lieu of a single static pressure regulator 52, being disposed upstream of a single set of standard solenoid valves 52 with each of the concentrate stream 18a and the diluate stream 18b flowing through its own EPR 54′. FIG. 3C illustrates a circuit architecture 150″ having an architecture similar to that of FIG. 3A, with two multichannel solenoid valves 52′ being used in each set of valves 48′, 50′ in lieu of four standard solenoid valves 52. FIG. 3D illustrates a circuit architecture 150′″ having an architecture similar to that of FIG. 3B, with two multichannel solenoid valves 52′ being used in lieu of standard solenoid valves 52 in the single set of valves that is disposed downstream of a pair of EPRs 54′. The circuit architectures in FIGS. 3B-3D also have improved recovery ratios as compared to RO desalination systems and are viable for use in the ED system 100 of the present embodiments, and because each architecture 150′, 150″, 150′″ implements similar types of components, a detailed discussion of these architectures is omitted herein for the sake of brevity. A person skilled in the art will understand how to read the architectures 150′, 150″, 150′″, in view of his or her knowledge and the present disclosure, and also understand how each architecture 150′, 150″, 150′″ operates. Moreover, at least because some components (e.g., the electronic pressure regulators 54′ and multichannel solenoids 52′) of these architectures may be cost prohibitive and/or less readily available, the architecture of FIG. 3A can be preferred. It will be appreciated that to the extent that flows in FIGS. 3B-3D are labeled in a manner that resembles that of FIG. 3A, it can be assumed that the function of such flows remains unchanged. Moreover, while the circuit architecture 150 of the valve manifold system 104 is discussed as having two sets of four valves, other orientations are possible, as understood by a person skilled in the art in view of the present disclosures.

FIG. 3E illustrates an alternate embodiment of a circuit architecture 150″″ that can be used to optimize the reversal module architecture of a valve manifold system 104″″. As shown, the circuit architecture 150″″ can include the set of valves 50 disposed downstream of the ED stack 10, with no upstream set of valves, followed by the static pressure regulator 54 in the concentrate water stream 20. In some embodiments, this configuration can result in some degree of internal leakage from the concentrate stream 18a into the diluate stream 18b, though this internal leakage may be appropriately minimized for different geometries of the end cap 16 and/or flow path. In some embodiments, the circuit architecture 150″″ can include a bypass valve 23 that can be used during the flush cycle. As shown, the bypass valve 23 can be disposed along the concentrate water stream 20 to avoid pressure spikes within the circuit architecture 150″″. For example, running the pump 102 at constant power can cause undesired pressure spikes, which can, in turn, cause unwanted leakage. Use of the bypass valve 23 can avoid these spikes by relieving pressure in the stream when pressure gets to be too high. Alternatively, in some embodiments of the circuit architecture 150″″, the bypass valve 23 can be omitted and the power of the pump 102 can be modulated during the flush cycle to regulate the pressure of the circuit architecture 150″″. Reducing the power of the pump 102, for example, can decrease the power during the flush cycle, and can allow it to be increased when returning to an acceptable pressure.

FIG. 3F illustrates an alternate embodiment of a circuit architecture 150″″″ that can be used to optimize the reversal module architecture of a valve manifold system 104″″″. The circuit architecture 150″″ can be used to minimize the pressure differential across the ion exchange membranes (cation exchange membrane (CEM) 30 and the anion exchange membrane (AEM) 32). For example, as shown, the circuit architecture 150″″ can include the first set of valves 48 upstream of the ED stack 10, the second set of valves 50 downstream of the ED stack 10, and a pair of static pressure regulators 54, with one located upstream and one downstream of the ED stack 10. Moreover, the bypass valve 23 can be placed on the downstream stack pressure regulator 54, as in FIG. 3E. This configuration can be useful when using thinner ion exchange membranes that may be more likely to deform under a given pressure differential.

For the purposes of the present disclosure, it will be appreciated that the various components of any of the disclosed configurations, e.g., at least the configurations of the circuit architectures of FIGS. 3A-3F, can be mixed and matched to create the circuit architectures as described, illustrated, and/or understood by a person skilled in the art in view of the present disclosures. Moreover, it will be appreciated that any number of the above-disclosed features can be combined in a single configuration, e.g., varying numbers of valves 52, static pressure regulators, and so forth, to form the existing configurations and/or alternate configurations that exhibit a desired property of the circuit architecture.

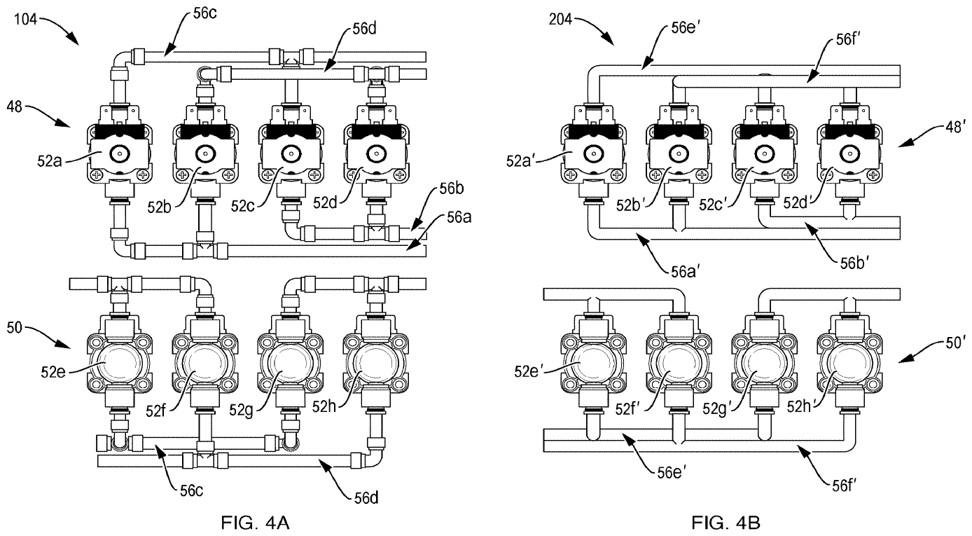

FIG. 4A illustrates the valve manifold system 104 in greater detail, while FIG. 4B illustrates an alternate embodiment of a valve manifold system 204. For example, each set of valves 48, 50 can be connected such that a pair of valves share a common bus or conduit 56 for flowing a fluid therethrough. As shown, for example, valves 52a, 52b can be connected by a first conduit 56a and valves 52c, 52d can be connected by a second conduit 56b on the input side. While valves 52a, 52b are shown as connected or bussed by the first conduit 56a at the input side, it will be appreciated that in some embodiments, the first conduit 56a can connect valves 52a, 52c, or 52a, 52d, or 52b, 52c, and so forth, at the input side. Moreover, in configurations in which valves 52a, 52b are bussed by the first conduit 56a at the input side, valves 52a, 52c can be bussed by a third conduit 56c at the output side, as shown.

The first set of bussed valves 48 can enable the pressure-regulated concentrate stream 18a and the diluate stream 18b to be sent to either (or both) of the two channels in the electrodialysis stack 10. The second set of bussed valves 50 can enable either (or both) of the channels in the electrodialysis stack 10 to route clean water to the product tank 126 or the contaminated electrode rinse stream 26 that can exit the outlet and be discarded to waste via the electrode rinse and disposal valve. The routing options on the input and output may be matrixed to facilitate different functions and controlled electronically. Functions may include the reversal of the concentrate 18a and diluate streams 18b to increase the longevity of the stack, halt production of clean water, and/or fully flush the system to the disposal valve in between cycles.

Similarly, conduits 56e, 56f, 56g, 56h can connect any pair of valves 52e, 52f, 52g, 52h of the second set of valves 50, though, as shown, conduit 56c can skip an intermediate valve to connect valves 52e, 52g, and conduit 56d can skip an intermediate valve to connect valves 52g, 52h. The valves 52a-52h can have standard fittings with flow dividers 46 disposed between valves to branch and/or split fluid flowing to each of the valves 52a-52h.

FIG. 4B illustrates an alternate embodiment of a valve manifold system 204 having custom molded buses 56a′-d′. The custom molded buses can be injection molded directly to the valves 52a′-52h′ in lieu of using fittings, e.g., plastic molded quick connects, to connect a pair of valves. As shown, the buses 56a′-56d′ can connect to the valves 52a′-52h′ in a similar orientation to that of FIG. 4A, though alternate orientations are possible. Injection molded buses 56a′-d′ can reduce a number of points of failure that exist with standard fittings, e.g., a reduction of about 30 to about 40 points of failure as compared to standard fittings.

FIG. 5A illustrates an example embodiment of a cabinet 200 that includes the ED system 100 of the present embodiments. The cabinet 200 can be sized to fit the components of the ED system 100 shown in FIG. 2B into an RO cabinet by replacing and/or repurposing some components of an RO cabinet, such as an Eureka Forbes Limited (EFL) Astor Cabinet and/or Royale Cabinet, as shown in FIG. 5B. As shown, the cabinet 200 can include the pump 102, the valve manifold system 104, the acid dose vessel 108, the infuser 122, the product tank 126, and other components of the ED system 100 disposed within the cabinet 200. A primary challenge in assembling the cabinet 200 can be inserting the ED stack 10 and the valve manifold system 104 as compactly as possible, while accommodating for both the components carried over from the RO unit 200′, as well as the additional new support components that are shown in FIG. 5A and illustrated in the table in FIG. 5C, as discussed below. The weight of the ED stack 10 and the valve manifold system 104, e.g., solenoids, can provide a stable center of gravity, which can be accomplished by central placement of such components within the cabinet 200. It will be appreciated that the ED stack 10 can stand vertically within the cabinet 200 to minimize leakage and/or can be placed in the rear of the unit to prevent tampering by users thereof.

Most conventional EFL cabinets, regardless of range, can be made to occupy an estimated 300 mm×280 mm×500 mm rectilinear envelope, though each product's encasement can be spatially optimized based on its interior components. In the Astor, for example, concave curves cut out the back corners of the enclosure, and, if more space is required, squaring off these corners can not only add interior volume, but also improve the ratio of usable space to unusable space (currently approx. 1:2). It will be appreciated that the cabinet 200 of the present embodiments can be sized to mimic the EFL cabinet, e.g., about 300 mm×about 280 mm×about 500 mm rectilinear envelope, to fit the desalination system 100 of the present embodiments.

FIG. 5C illustrates a comparison of an example embodiment of a volumetric breakdown of components between the prior art RO cabinet 200′ and the cabinet 200 of the present embodiments. As shown, a 7-Liter product tank 126 can occupy approximately 25.72% of the volume of the cabinet 200. About half of that space by-volume (14.45%) may be occupied by the ED stack 10 with its maximum thickness end caps (9.17%) and the reversal solenoids (5.28%). The RO cabinet 200′ may employ a 4 bar of pressure, 1.1 L/min flow rate feed pump 102′ that occupies 5.39% of the cabinet volume, while the pump 102 of the present embodiments can use 2.4 bar of pressure and 2 L/min flow rate, which meets the requirements to support ED and only occupied 1.04% of the cabinet volume, or one-fifth the size of the pump 102′. Moreover, as discussed above, an antiscalant tube 110 and a 100 mL acid dosing module 108 can be introduced into the ED cabinet 200, while the Pre-Ag filter 113′ and RO filter 115′ have both been removed. Additionally, the sediment filter 111, UV filter 124, post-carbon filter 122, and DC adapter 128 have all carried over to the ED cabinet 200 from the RO cabinet 200′. The remaining free space in the ED cabinet 200 can be broken into two categories: usable and unusable, where usable represents rectilinear voids where additional components currently not accounted for (e.g., control printed circuit boards (PCBs)) can be integrated into future iterations of the design and unusable space where no additional components can be added. While the amount of unusable space exhibits negligible change in the two configurations, the ED cabinet 200 has just under half the amount of usable free space remaining, suggesting a more densely packed cabinet and maximization of the usable space to fit the components of the ED system 100 therein.

FIG. 6 illustrates a side view of the cabinet 200, showing the orientation of the tubing 210 for allowing the components to maintain fluid communication within the cabinet 200. As shown, the tubing 210 can be disposed at angles and/or staggered to maximize space for the ED system 100 within the cabinet. For example, while the solenoids 52 of the first set 48 and the second set 50 of solenoid valves 52 are oriented to pass water through vertically, 90° angle press-fits, T/Y-Splits, and short lengths of tube are utilized to bus solenoids together horizontally, effectively creating an ad hoc “multi-channel” solenoid system in as efficient a space as possible. By flipping the input block and the output block 180°, approximately 20 mm of vertical footprint can be saved by layering the tubing. Moreover, if the press-fits and tubing can be consolidated into custom injection-molded components, part counts, assembly time, and/or points of failure could be further reduced.

### Brackets

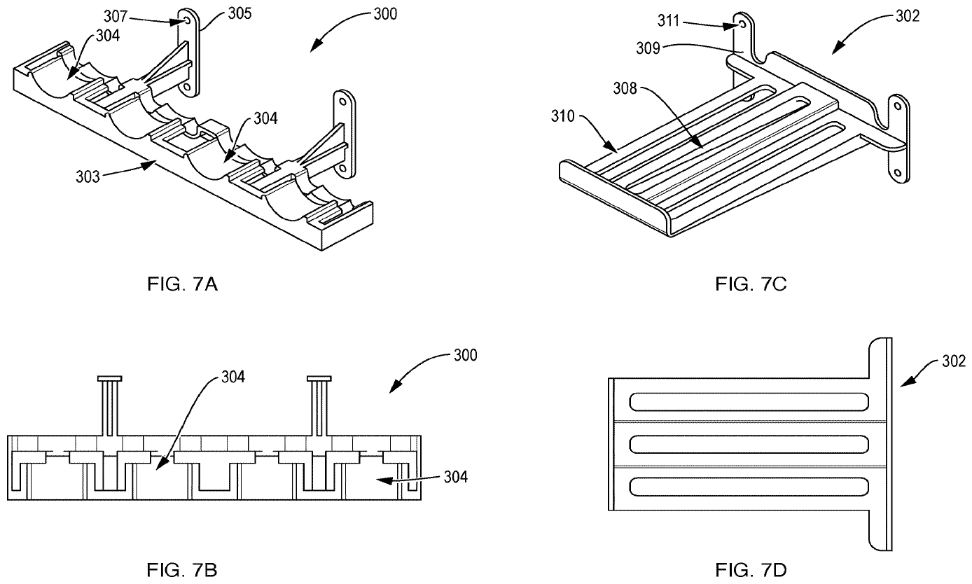

FIGS. 7A-7D illustrate some exemplary embodiments of brackets that can be used with one or more components of the ED system 100 and/or the cabinet 200 of the present embodiments. As shown, FIGS. 7A-7B illustrate brackets 300 that support the valve manifold system 104, and FIGS. 7C-7D illustrate brackets 302 that support the ED cabinet 200. The design of the brackets 300, 302 can adhere to design for manufacturing (DFM) considerations for injection-molding with consistent wall thickness, zero undercuts, and/or minimized material where possible. In some embodiments, the brackets 300, 302 can be fabricated using 3D.

Solenoid brackets 300 can be configured for snap-fit fastening to the valve manifold system 104 to support the first and second sets 48, 50 of solenoid valves 52. As shown, the brackets 300 can include a custom-fit bed 303 having one or more recesses 304 for receiving each of the solenoid valves 52 therein. While the embodiment of FIG. 7A illustrates a bed 303 that fits four solenoid valves 52 together, it will be appreciated that three or less or five or more solenoid valves can be supported by the solenoid bracket 300, the configuration typically being suitable to fit the number of solenoid vales being used in conjunction with that bracket. The solenoid bracket 300 can include one or more extensions 305 having one or more coupling features 307, as shown receiving holes to receive, by way of example, a screw, for coupling the solenoid bracket 300 to a surface within the cabinet 200 or another feature of the ED system 100.

As shown in FIGS. 7C and 7D, the ED stack bracket 302 can be oriented on either side of the ED stack 10 to allow the ED stack 10 to be hung, e.g., disposed on a vertical wall or another surface. As shown, the ED stack bracket 302 can include one or more extensions 309 having one or more coupling features 311, as shown receiving holes to receive, by way of example, a screw, for said coupling. In the ED stack bracket 302, the bracket can include a “center-out” design with a raised center section 308 based on a range of about 22 millimeters to about 24 millimeter thickness of the pressure-applied membranes, while keeping the outer edges 310 open to account for geometric tolerance when receiving the end caps 16a, 16b. Each unit can use two brackets 302, a top and bottom, to compress and/or hold the ED stack 10 in place. In some embodiments, due to the weight of the ED stack 10, the bottom bracket can rest on an inset in the enclosure for the feed and disposal valves. The diagonal support ribbing on the underside of the bracket 302 can terminate to provide a flat segment that can allow the bracket 302 to rest on any inset from the exterior enclosure.

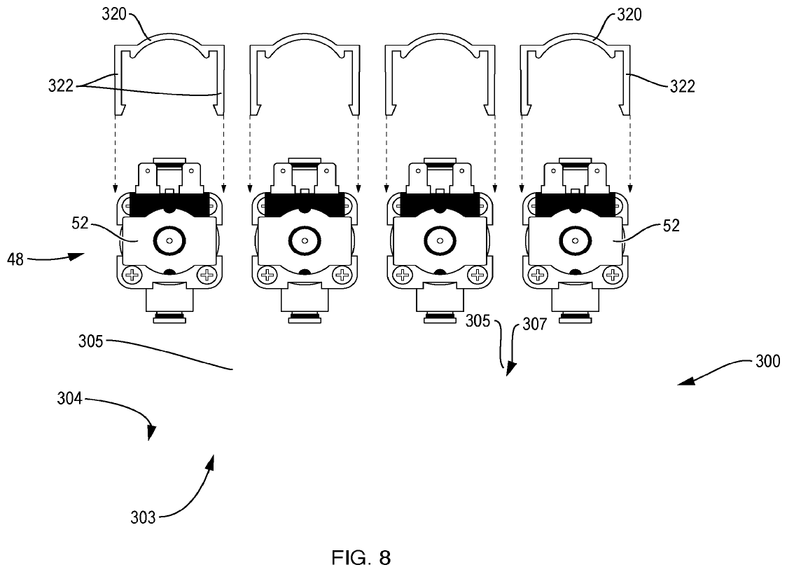

FIG. 8 illustrates an embodiment of a snap-fit brace 320 that can be used with the valve manifold system 104 of the present embodiments. As shown, a plurality of snap-fit braces 320 can be configured to be disposed around each solenoid valve 52 of the first set of valves 48, though it will be appreciated that the braces 320 can be used with the solenoid valves 52 of the second set of valves 50. Each brace 320 can include a pair of arms 322 that can engage the solenoid valve 52 to secure each valve into position and/or allow technicians to swap out individual components without disturbing the entire set of valves 48.

In some embodiments, sheet metal can be used in lieu of brackets to support one or more components of the ED system 100 and/or the cabinet 200 of the present embodiments. For example, ED system components can be made from and/or fastened to sheet metal to allow the ED stack 10 to be hung, e.g., disposed on a vertical wall or another surface. A person skilled in the art will appreciate other structures that can also be used in lieu of and/or in addition to brackets, sheet metal, etc. (e.g., shelves, manifolds).

### End Caps

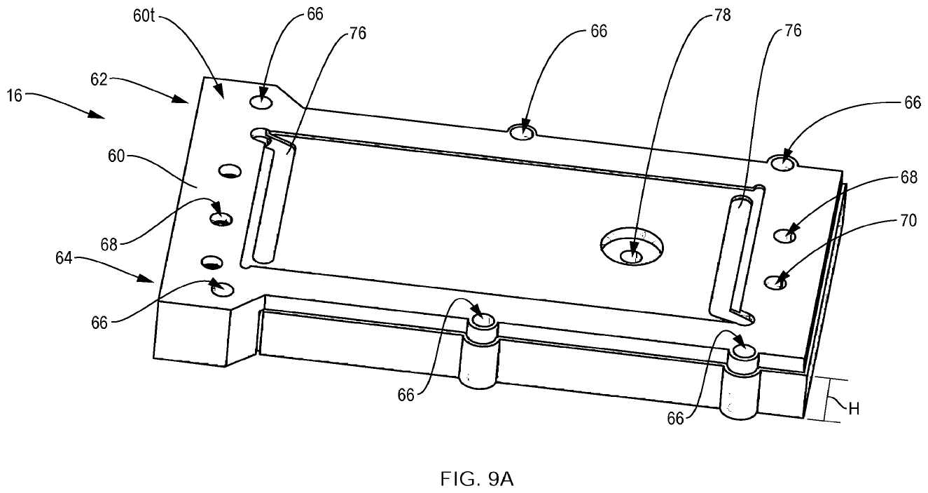

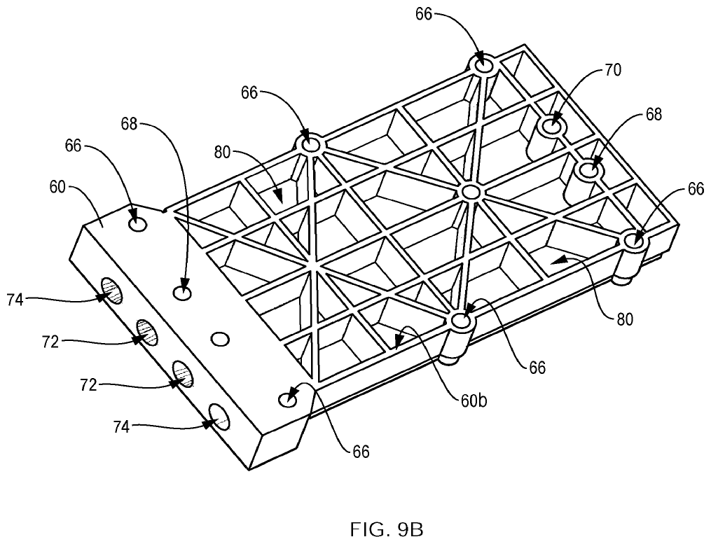

FIGS. 9A-9B illustrate one example embodiment of an endcap 16 used with the ED stack 10 of the present embodiments. The end cap 16 can be used as the end cap 16a and the end cap 16b, and thus references to the same herein may be interchangeable. The end caps 16 can be added to the ED stack 10 to prevent leakage therefrom, to house the electrodes, and/or to route inlet and outlet flow paths, among other purposes. The end caps 16a, 16b can be sufficiently stiff, e.g., made of steel, to provide compression to the stack membranes 12, while also minimizing the amount of material to minimize end cap weight, volume, and cost. For example, the end caps 16a, 16b of the present embodiments can be injection molded to be thin and light to reduce material cost, while being sufficiently stiff for appropriate load distributions and sealing.

Two pressures were principally considered when designing the disclosed end caps: (i) a distributed load from pressure due to water flow through the ED stack 10; and (ii) reaction forces applied via the end cap bolts through preload. These two pressures tend to push the end caps apart, which can cause them to bow in the center. Further, while the preload pressure works to compress and seal the membranes 12a, 12b, the water pressure can work to push the membranes apart, causing leakage. The leakage may occur either at the outer perimeter of the stack 10, or inside of the stack 10 in between membranes 12a, 12b which may cause the fluid circuit to short circuit, reducing the water flow path length and thus reducing the salt removal efficiency of the ED stack 10.

An experimental model coupled with a simulation to estimate the minimum pre load for varying end cap geometries can be found below. For example, a scalar salt removal effectiveness metric can be defined:

$$effectiveness = \frac{concentrate TDS - diluate TDS}{feed TDS} \qquad ( 1 )$$

which can be based on measuring the TDS of the inflowing feed water and the outflowing concentrate and diluate streams. In some embodiments, the feedwater supply can be set at approximately 1000 ppm TDS, and then a TDS sensor can be used to find the salinity of the feedwater. At baseline, when the water is running through the stack without the desalination function turned on, the TDS of the concentrate and diluate streams can each be equal to the feed TDS, giving an effectiveness of 0. The maximum possible effectiveness can be 2, when all salt from the diluate is removed to the concentrate. When there is internal stack leakage, the effectiveness of the system can decrease. The goal can be to ensure that the end caps 16a, 16b maximize this effectiveness value, without changing any of the other operational settings of the ED system 100. When salt removal operational settings are held constant, the primary variable that can influence the effectiveness is the time the water spends within the stack, and so effectiveness can be used as a measure of internal stack leakage. It will be appreciated that effectiveness is a universal parameter that can be applied to other membrane geometries of similar channel width and height, and is independent of the end cap geometry. The experimental setup can be used to design end caps for different membrane geometries without having to physically prototype the end caps on each iteration to know if the effectiveness condition will be satisfied. Further, the framework can also be used to design end caps with less material while ensuring they meet their stiffness requirement to prevent leakage of the ED stack 10, as discussed above, without including reinforcement features when disposed in the cabinet 200.

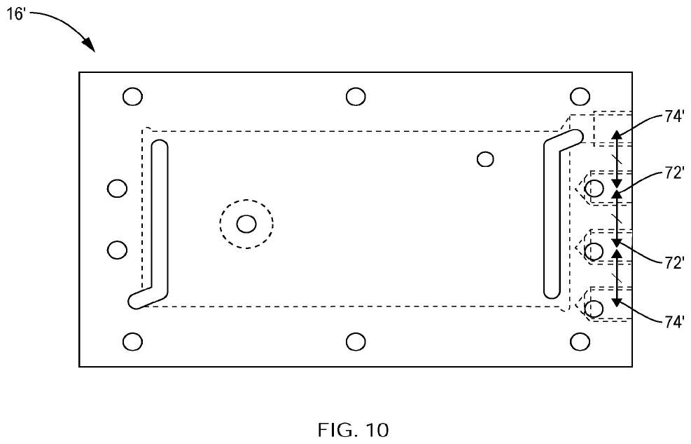

The end caps 16a, 16b can be manufactured to be identical to eliminate variability and reduce capital costs of manufacture by using a single mold to make both end caps. For example, the end caps 16a, 16b can have non-handedness, e.g., rotational symmetry, as shown in FIG. 10, which can allow either of the end caps 16a, 16b to be placed on the top and/or on the bottom of the ED stack 10. Put another way, when features of the end cap 16 are discussed below, it will be recognized that these features can apply to either of the end caps 16a, 16b. Conventional designs used different end caps, which complicates the fabrication process, among other drawbacks appreciated by those skilled in the art.

The end cap 16 can offer at least two major improvements over conventional end cap designs. First, the end cap 16 of the present embodiments can feature a modified design that facilitates assembly of the ED stack 10. Second, the end cap 16 of the present embodiments can simplify the process of manufacturing the end cap 16.

Turning back to FIGS. 9A-9B, as shown in FIG. 9A, the end cap 16 can include a body 60 having a series of openings formed therein. Some of the series of openings can help secure the end cap 16 to the ED stack 10 to prevent leakage, while other openings can be used to facilitate fluid communication within the ED stack 10.

As shown, the body 60 can include two rows 62, 64 of bores 66 formed therein for securing the end cap 16 to the ED stack 10. The bores 66 can be manufactured to withstand stresses and displacements on the end cap 16, such as that which occurs during minimum membrane compression and/or other preload forces exerted onto the end cap 16 that may cause the end cap to deflect during use. It will be appreciated that while the bores 66 are located on the periphery of the body, typically the bores 66 should be sufficiently strong to support deflection in a center of the end cap 16, which is most prone to leaking. Each of the bores 66 can extend through a thickness or height H of the body 60 from a top surface 60t to a bottom surface 60b, as shown in FIG. 9A, to receive one or more coupling instruments (not shown) therethrough to couple the end cap 16 to the remainder of the ED stack 10. Coupling instruments include, but are not limited to, bolts, snaps, straps, ultrasonic welding, rivets, pins, and/or screws. A height of the end cap 16 can be about 1.5 inches or less, about 1.25 inches or less, and/or about 1 inch or less.

The end cap 16 can include one or more throughholes 68 therein for receiving an alignment pin or rod (not shown) therethrough. The throughholes 68 can correspond to openings in the ED stack 10 to ensure that the end cap 16 aligns with the remainder of the ED stack 10 to prevent leakage. By inserting an alignment pin through the throughhole 68 into the corresponding opening, a predetermined position of the end cap 16 relative to the ED stack 10 can be confirmed. The throughholes 68 can be positioned in these locations to have rotational symmetry of the end cap 16 relative to the ED stack 10 and/or allow the end cap 16 to be coupled to the top or bottom of the ED stack 10.

The end cap 16 can include a sacrificial valve port 70. The sacrificial valve port 70 can facilitate use of a single mold for both end caps 16a, 16b to allow asymmetry by plugging one hole or the other. In some embodiments, the sacrificial valve port 70 can be plugged in during assembly of the ED stack 10. Moreover, in addition to the sacrificial valve port 70, the end cap 16 can include inlet valves 72 and outlet valves 74, as shown in FIG. 9B. The inlet valves 72 and the outlet valves 74 can be positioned equidistant from one another, as shown, and as indicated by the arrows in an alternate embodiment of the end cap 16′ of FIG. 10, for example, with inlet valves 72′ and outlet valves 74′. This differs from conventional end caps, in which a distance between the valves can vary. It will be appreciated that the remaining features of the end cap 16′ function similar to those of the embodiments of FIGS. 9A-9B.

The end cap 16 can include a pair of electrode rinse channels 76. The electrode rinse channels 76 can be modified to be asymmetrical, as shown, by pointing in opposite directions, which differs from conventional channels that point in the same direction. In some embodiments, the electrode rinse channels 76 can be symmetrical, e.g., exhibit rotational symmetry. The electrode rinse channels 76 can allow the contaminated electrode rinse stream 26 to pass from the electrode 14, out of the ED stack 10.

In some embodiments, the inlet valve 72 of the end cap 16a can receive the concentrate feed stream 18a therethrough at a feed stream salinity, another inlet valve 72 to receive the diluate feed stream 18b therethrough at a feed stream salinity, and an inlet valve 72 to receive the electrode rinse stream 24 therethrough to be passed to the electrode rinse channel 76. The end cap 16b can include an outlet valve 74 to pass the diluate water stream 22 having a diluted, e.g., less concentrated salinity, feed stream out of the end cap 16b to the product tank 126, another outlet valve 74 to pass the concentrate water stream 20 having a concentrated salinity feed stream pass as wastewater W to the acid dosing pressure pump 106, and an electrode rinse outlet 74 having a concentrated contaminated electrode rinse stream 26 going to the drain.

The end cap 16 can include an electrode connection 78, which can be modified from conventional end caps by allowing it to sit flush with a surface of the electrode 14 in the ED stack. The electrode connection 78 can be further modified as compared to conventional end caps by being placed in the inner periphery, e.g., towards the middle of the end cap 16, rather than along a periphery thereof. End caps 16 that sit flush with the electrodes can minimize leakage at the electrode connection 78.

In some embodiments, the end cap 16 can be ribbed. It will be appreciated that any feature that contains excess volume may become ribbed to decrease a weight of the structure such that it is more lightweight. A ribbed design can allow for uniform, thin wall thickness everywhere along the end cap 16, making it suitable for injection molding and most cost effective for large production volumes. An optimization study can be conducted with the end caps to determine the optimal geometry in terms of cost, ease, and quality of injection molding, and compatibility with surrounding components within the cabinet.

FIG. 9B illustrates the bottom surface 60b of the end cap 16. As shown, the bottom surface 60b can include a series of recesses 80. The recess can be shaped to receive a portion of the electrode 14 and/or the membrane therein. Receiving portions of the remaining components of the ED stack 10 within the recesses 80 can allow the end cap 16 to sit more flush with respect to the overall ED stack, which can reduce leakage.

Examples of the above-described embodiments can include the following:
1. A valve manifold system, comprising:
   a matrix of valves having a set of valves located downstream of an electrodialysis stack that includes one or more membranes disposed between a pair of electrodes;
   a static pressure regulator in fluid communication with the matrix of valves, the static pressure regulator being located on a concentrate output stream;
   a flow divider configured to separate a feed stream into a concentrate feed stream and a diluate feed stream prior to entry into the matrix of valves; and
   a bypass valve that allows the concentrate output stream to bypass the static pressure regulator.
2. The system of example 1, wherein a ratio of the flow rate of the diluate feed stream to the concentrate feed stream through the matrix of valves is approximately in a range of about 20:1 to about 1:1.
3. The system of example 1 or example 2, wherein the static pressure regulator is located downstream of the electrodialysis stack.
4. The system of any of examples 1 to 3, wherein the static pressure regulator is located downstream of the matrix of valves.
5. The system of any of examples 1 to 4, further comprising a flow divider configured to flow the concentrate output stream through the bypass valve.
6. The system of any of examples 1 to 5, wherein the bypass valve is configured to be bypassed during a flush cycle when a power of a pump that is in fluid communication with the valve manifold system and the electrodialysis stack is modulated.
7. The system of any of examples 1 to 6, wherein the static pressure regulator is configured such that the concentrate output stream exiting the set of valves flows through the static pressure regulator before exiting as wastewater.
8. The system of any of examples 1 to 7, wherein the set of valves comprises a first pair of valves that are in fluid communication with one another and a second pair of valves that are in fluid communication with one another.
9. The system of any of examples 1 to 8, wherein the matrix of valves further comprises a second set of valves being located upstream of the electrodialysis stack.
10. The system of example 9, wherein the second set of valves comprises a first pair of valves that are in fluid communication with one another and a second pair of valves that are in fluid communication with one another.
11. The system of example 9 or example 10, further comprising a second static pressure regulator located upstream of the matrix of valves or the electrodialysis stack, the second static pressure regulator being located on a concentrate feed stream and in fluid communication with the second set of valves.
12. The system of any of examples 9 to 11, further comprising:
   a first input conduit connecting an input side of the first pair of the first set of valves; and
   a second input conduit connecting an input side of the second pair of the second set of valves.
13. The system of example 12, further comprising:
   a first output conduit connecting an output side of a first valve of the first pair of valves and a first valve of the second pair of valves; and
   a second output conduit connecting an output side of a second valve of the first pair of valves and a second valve of the second pair of valves.
14. The system of example 13, wherein at least one or more of the first input conduit, the second input conduit, the first output conduit, or the second output conduit comprises a custom molded bus without fittings.
15. The system of any of examples 1 to 14, wherein a diluate output stream exiting the second set of valves flows to a product tank.
16. The system of any of claims 1 to 15, wherein a recovery ratio of the product in the product tank is approximately in a range of about 50% to about 95% of the feed stream circulating through the system.
17. The system of any of examples 1 to 16, further comprising one or more brackets having a body with one or more recesses configured to receive a valve from the matrix of valves therein, the body having one or more extensions configured to couple the bracket to a supporting surface.
18. A valve manifold system, comprising:
   a matrix of valves having a first set of valves and a second set of valves, the first set of valves being located upstream of an electrodialysis stack that includes one or more membranes disposed between a pair of electrodes, and the second set of valves being located downstream of the electrodialysis stack;
   a static pressure regulator in fluid communication with the matrix of valves; and
   a flow divider configured to separate a feed stream into a concentrate feed stream and a diluate feed stream prior to entry into the matrix of valves.
19. The system of example 18, wherein the static pressure regulator is located upstream of the matrix of valves or the electrodialysis stack, the static pressure regulator being in fluid communication with the first set of valves.
20. The system of example 18 or example 19, wherein the static pressure regulator is located on the concentrate feed stream.
21. The system of any of examples 18 to 20, wherein:
   at least one of the first set of valves comprises a first pair of valves that are in fluid communication with one another and a second pair of valves that are in fluid communication with one another, or
   at least one of the second set of valves comprises a first pair of valves that are in fluid communication with one another and a second pair of valves that are in fluid communication with one another.
22. The system of any of examples 18 to 21, wherein a recovery ratio of the product in the product tank is approximately in a range of about 50% or more of the feed stream circulating through the system.
23. The system of any of examples 18 to 22, wherein the matrix of valves is configured to flip the concentrate feed stream and the diluate feed stream prior to entry into the electrodialysis stack.
24. The system of any of examples 18 to 23, wherein the matrix of valves is configured to flip a concentrate output stream and a diluate output stream after exiting the set of valves.
25. A desalination system, comprising:
   a pump;
   a valve manifold system in fluid communication with the pump; and
   an electrodialysis stack that includes one or more membranes disposed between a pair of electrodes, the electrodialysis stack being in fluid communication with the pump and the valve manifold system,
   wherein a feed stream circulates, in sequence, from the pump into the valve manifold system, with the feed stream being split in the valve manifold system into a concentrate stream and a diluate stream that exit the valve manifold system, the concentrate stream and the diluate stream being fed through the electrodialysis stack for ion removal via the one or more membranes, the concentrate stream and the diluate stream exiting the electrodialysis stack into the valve manifold system, with the concentrate stream exiting the valve manifold system as waste and the diluate stream exiting the valve manifold system as a product, and
   wherein a recovery ratio of the product is approximately in a range of about 50% or more of the feed stream circulating through the system.
26. The system of example 25, wherein the desalination system is disposed in a cabinet having the dimensions of a conventional reverse osmosis (RO) cabinet.
27. The system of example 25 or example 26, wherein the desalination system is configured to fit within a rectilinear envelope measuring about 300 mm×about 280 mm×about 500 mm.
28. The system of claim any of examples 25 to 27, wherein the valve manifold system further comprises a first set of valves and a second set of valves, the electrodialysis stack being disposed downstream from the first set of valves and upstream of the second set of valves.
29. The system of example 28, the product flows through one or more of a conductivity sensor, a pH sensor, an infuser, a UV filter, or a product tank after exiting the second set of valves.
30. The system of any of examples 25 to 29, further comprising an acid dosing pressure pump and an acid dose vessel in fluid communication with one or more of the pump or the valve manifold system, the acid dosing vessel being configured to receive waste exiting the valve manifold system via the acid dosing pressure pump.
31. The system of any of examples 25 to 30, wherein the one or more membranes further comprises:
   a cation membrane; and
   an anion membrane separated by one or more spacer membranes, the cation membrane and the anion membrane having a tortuous channel formed therein.
32. The system of any of examples 25 to 31, further comprising a pair of end caps, with each end cap engaging an electrode of the pair of electrodes without reinforcement features to facilitate the coupling.
33. The system of example 31 or example 32, wherein the concentrate stream and the diluate stream enter a first end cap of the pair of end caps, the feed stream being split into a concentrated water stream and a diluate water stream that exits a second end cap of the pair of end caps.
34. The system of example 33, wherein the one or more membranes are coupled to the pair of end caps without a center support member.
35. The system of example 34, further comprising an electrode rinse stream that passes from the acid dose vessel to the first end cap of the pair of end caps, with a contaminated electrode rinse stream exiting a second end cap of the pair of end caps.
36. The system of any of examples 25 to 35, further comprising one or more of an antiscalant, a conductivity sensor, a feed water tank, or a feedwater inlet that are in fluid communication with the pump to flow the feed stream from the feedwater inlet, through the pump, and into the valve manifold system.
37. The system of any of examples 25 to 36, wherein a recovery ratio of the product is approximately in a range of about 50% to about 95% of the feed stream circulating through the system.
38. The system of any of examples 25 to 37, wherein a recovery ratio of the product is approximately in a range of about 50% to about 90% of the feed stream circulating through the system.
39. The system of any of examples 25 to 38, wherein the concentrate stream is configured to recirculate through the pair of electrodes to rinse the electrodes.
40. The system of any of examples 25 to 39, further comprising a static pressure regulator configured to reduce a flow rate in the concentrate stream relative to the diluate stream.
41. An end cap, comprising:
   a body having a top surface, a bottom surface, and a plurality of bores extending from the top surface to the bottom surface for coupling the body to an electrodialysis stack;
   one or more inlet valves and outlet valves disposed equidistant from one another within the body;
a pair of asymmetrical electrode rinse channels terminating at the one or more outlet valves; and
an electrode connection formed at an inner periphery of the end cap,
   wherein the end cap comprises rotational symmetry such that the end cap is configured to be coupled to a top or bottom of the electrodialysis stack.
42. The end cap of example 41, wherein the end cap is devoid of reinforcement features for coupling the end cap to the electrodialysis stack.
43. The endcap of example 42, further comprising one or more throughholes for receiving an alignment pin therein, the alignment pin being keyed to couple to the electrodialysis stack in a single orientation to prevent leakage therefrom.
44. A method of desalinating a feed stream, comprising:
   flowing at least a portion of a feed stream through a flow restrictor;
   flowing at least another portion of the feed stream and the stream exiting the flow restrictor through a matrix of valves and an electrodialysis stack that includes one or more membranes disposed between a pair of electrodes; and
   separating a fluid from a salt content in the feed stream to form a product.
45. The method of claim 44, further comprising splitting the feed stream into a concentrate feed stream and a diluate feed stream.
46. The method of example 45, wherein the feed stream is flowed through a flow divider to split the feed stream.
47. The method of example 45 or example 46, further comprising flipping the concentrate feed stream and the diluate feed stream via the matrix of valves prior to entry into the electrodialysis stack.
48. The method of any of examples 44 to 47, wherein the matrix of valves comprises a first set of valves disposed upstream of the electrodialysis stack and a second set of valves disposed downstream of the electrodialysis stack.
49. The method of any of examples 44 to 48, further comprising flowing at least a portion of a diluate stream exiting the second set of valves through a second flow restrictor.
50. The method of example 48, further comprising collecting the diluate stream exiting the second set of valves as product and discarding a concentrate stream exiting the second set of valves.

One skilled in the art will appreciate further features and advantages of the disclosures based on the provided for descriptions and embodiments. Accordingly, the inventions are not to be limited by what has been particularly shown and described. To the extent the present disclosure includes illustrations and descriptions that include prototypes, bench models, or schematic illustrations of set-ups, a person skilled in the art will recognize how to rely upon the present disclosure to integrate the techniques, systems, devices, and methods provided for into a product and/or production method, such as commercially viable ED systems across a variety of small, medium, and/or large scales. All publications and references cited herein are expressly incorporated herein by reference in their entirety.

Some non-limiting claims that are supported by the contents of the present disclosure are provided below.

What is claimed is:

1. A valve manifold system, comprising:
a matrix of valves having a set of valves located downstream of an electrodialysis stack that includes one or more membranes disposed between a pair of electrodes;
a static pressure regulator in fluid communication with the matrix of valves, the static pressure regulator being located on a concentrate output stream;
a flow divider configured to separate a feed stream into a concentrate feed stream and a diluate feed stream prior to entry into the matrix of valves; and
a bypass valve that allows the concentrate output stream to bypass the static pressure regulator.

2. The system of claim 1, wherein the static pressure regulator is located downstream of the electrodialysis stack.

3. The system of claim 1, wherein the static pressure regulator is located downstream of the matrix of valves.

4. The system of claim 1, wherein the bypass valve is configured to be bypassed during a flush cycle when a power of a pump that is in fluid communication with the valve manifold system and the electrodialysis stack is modulated.

5. The system of claim 1, wherein the set of valves comprises a first pair of valves that are in fluid communication with one another and a second pair of valves that are in fluid communication with one another.

6. The system of claim 1, wherein the matrix of valves further comprises a second set of valves being located upstream of the electrodialysis stack.

7. The system of claim 6, wherein the second set of valves comprises a first pair of valves that are in fluid communication with one another and a second pair of valves that are in fluid communication with one another.

8. The system of claim 6, further comprising a second static pressure regulator located upstream of the matrix of valves or the electrodialysis stack, the second static pressure regulator being located on a concentrate feed stream and in fluid communication with the second set of valves.

9. A valve manifold system, comprising:
a matrix of valves having a first set of valves and a second set of valves, the first set of valves being located upstream of an electrodialysis stack that includes one or more membranes disposed between a pair of electrodes, and the second set of valves being located downstream of the electrodialysis stack;
a static pressure regulator in fluid communication with the matrix of valves; and
a flow divider configured to separate a feed stream into a concentrate feed stream and a diluate feed stream prior to entry into the matrix of valves.

10. The system of claim 9, wherein the static pressure regulator is located upstream of the matrix of valves or the electrodialysis stack, the static pressure regulator being in fluid communication with the first set of valves.

11. The system of claim 9, wherein the static pressure regulator is located on the concentrate feed stream.

12. The system of claim 9, wherein:
at least one of the first set of valves comprises a first pair of valves that are in fluid communication with one another and a second pair of valves that are in fluid communication with one another, or
at least one of the second set of valves comprises a first pair of valves that are in fluid communication with one another and a second pair of valves that are in fluid communication with one another.

13. The system of claim 9, wherein a recovery ratio of the product in the product tank is approximately in a range of about 50% or more of the feed stream circulating through the system.

14. The system of claim 9, wherein the matrix of valves is configured to flip the concentrate feed stream and the diluate feed stream prior to entry into the electrodialysis stack.

15. The system of claim 9, wherein the matrix of valves is configured to flip a concentrate output stream and a diluate output stream after exiting the set of valves.

16. A method of desalinating a feed stream, comprising:
flowing at least a portion of a feed stream through a flow restrictor;
flowing at least another portion of the feed stream and the stream exiting the flow restrictor through a matrix of valves and an electrodialysis stack that includes one or more membranes disposed between a pair of electrodes; and
separating a fluid from a salt content in the feed stream to form a product.

17. The method of claim 16, further comprising splitting the feed stream into a concentrate feed stream and a diluate feed stream.

18. The method of claim 17, further comprising flipping the concentrate feed stream and the diluate feed stream via the matrix of valves prior to entry into the electrodialysis stack.

19. The method of claim 18, wherein the matrix of valves comprises a first set of valves disposed upstream of the electrodialysis stack and a second set of valves disposed downstream of the electrodialysis stack.

20. The method of claim 16, further comprising flowing at least a portion of a diluate stream exiting the second set of valves through a second flow restrictor.
